(19) United States
(12) Patent Application Publication
(10) Pub. No.: US 2005/0086469 A1
(43) Pub. Date: Apr. 21, 2005

(54) Scalable, fault tolerant notification method

(75) Inventors: John Dunagan, Bellevue, WA (US); Nicholas J.A. Harvey, Cambridge, MA (US); Michael B. Jones, Redmond, WA (US); Marvin M. Theimer, Bellevue, WA (US); Alastair Wolman, Seattle, WA (US)

Correspondence Address: LEYDIG, VOIT & MAYER, LTD., TWO PRUDENTIAL PLAZA, SUITE 4900, 180 NORTH STETSON, CHICAGO, IL, 60601-6780, US

(73) Assignee: Microsoft Corporation, Redmond, WA (US)

(21) Appl. No.: 10/686,620

(22) Filed: Oct. 17, 2003

(51) Int. Cl. H04L 9/00

(52) U.S. Cl. 713/163

(57) ABSTRACT

A scalable, fault-tolerant, federated event notification method is described, wherein clients express interest in a topic by subscribing, and published event notifications are delivered to all current topic-subscribers. Event notifications are disseminated by a multicast tree that does not require participation by unwilling nodes. The multicast tree is constructed so that nodes belonging to the organization owning the tree do not rely on nodes outside the organization to forward message traffic. Event notifications are delivered using redundant tree-based application-level multicast to ensure reliable delivery.

### TECHNICAL FIELD

This invention relates generally to a multicasting infrastructure and, more particularly, to a multicasting infrastructure for providing a scalable, highly available multicasting event notification service and ensuring reliable delivery of event messages.

### BACKGROUND OF THE INVENTION

As ever-increasing numbers of computers are networked together on the Internet, the usefulness and importance of peer-to-peer (P2P) network applications and distributed databases have become evident. A peer-to-peer network is generally thought of as a self-managed network of computers in which there is no single server or controller responsible for maintaining the network. Because there is no central server, peer-to-peer networks scale well since the load created by new members is distributed across all members of the network, rather than a central server. This scalability makes peer-to-peer networks particularly amenable to multicast applications such as event notification systems and multimedia streaming.

Generally speaking, multicasting is communication between a single sending node and multiple receiving nodes in a network environment. For example, alert messaging is one of many types of event notification applications where peer-to-peer multicasting facilitates scalable dissemination of information on an event topic to a large group of subscribers. For example, where the event topic is the status of a network printer, computers in that network may subscribe to event messages, e.g. a “toner low” message, issued by that printer. In a traditional network environment, a central server would send the message to each topic subscriber individually. However, in a peer-to-peer network, the message is sent only to a small subset of group members, who then each forward the message on to another subset of group members, and so on until all subscribers have received the message.

Multicasting applications often require messages to be routed to group members in a specific manner. However, the generic routing protocols of the Internet (e.g. Internet Protocol or “IP” routing) do not provide support for application-specific routing—i.e., message routing specific to particular needs of an application. To overcome this problem, multicasting applications use an “overlay network” to provide application-level routing so that applications may determine how messages are routed among nodes. An overlay network is a network infrastructure that operates on top of a general network infrastructure, such as the Internet. The overlay network typically relies on the underlying network-level routing protocols (e.g., IP routing) of the general network to send messages among its member computers. However, an application running on an overlay network member may decide how messages are routed between individual nodes that are part of the overlay network. One example of providing application-level routing is where an overlay network supports “routing by content,” where messages are routed to the node containing a specified item of data whose name is X, rather than routing to a specific node whose name is X.

One example of an overlay network providing application-level routing is an overlay network called Pastry (See, A. Rowstron and P. Druschel, “Pastry: Scalable, Decentralized Object Location, and Routing for Large-Scale Peer-to-Peer Systems,” IFIP/ACM International Conference on Distributed Systems Platforms (Middleware), pp. 329-350, Heidelberg, Germany, November 2001, which is hereby incorporated by reference in its entirety). Pastry assigns a unique numeric ID to each computer, i.e., node, in the overlay network. The set of all assigned numeric IDs is uniformly and randomly distributed over all nodes in the overlay network. Each node in the overlay network maintains a routing table listing a subset of the IDs. Each entry in the routing table maps a numeric ID to the associated node's IP address. When a node in the overlay network receives a message, it looks at the ID of the intended recipient, which is contained in the message, finds the numerically closest ID listed in its routing table, and then forwards the message to the associated node.

Multicasting infrastructures are known that rely on the application-level routing provided by overlay networks such as Pastry. An example of such a multicasting infrastructure is Scribe (See, M. Castro and P. Druschel and A. Kermarrec and A. Rowstron, “Scribe: A Large-Scale and Decentralized Application-Level Multicast Infrastructure,” IEEE Journal on Selected Areas in Communications (JSAC) (Special issue on Network Support for Multicast Communications), 20(8), October 2002, which is hereby incorporated by reference in its entirety), whose infrastructure organizes nodes in the overlay network into multicast groups, with each group having a tree topology for disseminating messages within the group. Scribe constructs multicast dissemination trees according to a technique called “reverse path forwarding.” A particular node in the overlay network is chosen to be the root or base node of the tree. Other nodes in the network wishing to join the tree learn of the identity of this root node—for example, by looking it up in a name service—and route a “subscription” message through the overlay network to the root node. At each intermediate node encountered by the subscription message along its path, a pointer is recorded in that node's multicast forwarding table, which points to the immediately preceding node that forwarded the message. This scheme of recording each hop along the path of the message as it travels from its source node to the root node results in the creation of a new branch in the dissemination tree, thus adding the node originating the subscription message to the multicast dissemination tree originating at the root node. Messages multicasted from the root node to the subscriber nodes follow the path of pointers originally laid by the subscription messages.

For multicasting applications, the Pastry overlay network allows messages to be routed across multiple administrative domains (e.g. ford.com), which means that nodes in one administrative domain must trust nodes in a foreign administrative domain to forward messages. For example, a Scribe multicast dissemination tree might contain nodes in two different administrative domains, such as ford.com and gm.com. Thus, a message from explorer.ford.com to mustang.ford.com might be routed through camaro.gm.com. This possibility results from Pastry's attempt to randomly and uniformly distribute the IDs for its infrastructure across the entire network. Pastry pays no attention to the security and reliability problems posed by routing messages across several domains.

Furthermore, the Scribe multicasting infrastructure requires that any node in the overlay network be willing to participate in any given multicast group. Inevitably, certain nodes in a multicast dissemination tree will not want to participate in multicast dissemination trees to which they did not themselves subscribe—i.e., they may decide not to forward messages on to other nodes. Because of the tree structure of the communication topology, a non-participating node could prevent some nodes in the tree from ever receiving the messages.

Therefore, there exists a need in the art for a multicasting infrastructure that provides a scalable, highly available multicasting event notification service and ensures secure, reliable delivery of event messages.

### SUMMARY OF THE INVENTION

In accordance with the invention, a multicasting infrastructure incorporates the path locality infrastructure of an overlay network to realize multicast dissemination trees that may reside either within a single administrative domain or may span multiple administrative domains. This multicasting infrastructure also provides for multicast dissemination trees comprising only nodes in the overlay network that are willing participants in message dissemination. By maintaining an infrastructure for multicasting that complements the domain structure of the larger network, applications running at the nodes of the overlay network are enabled to perform reliable and secure event notification messaging.

In keeping with the invention, multicast dissemination trees are implemented within the infrastructure of overlay networks providing path locality, such as SkipNet (described herein). This path locality ensures that when two nodes in the overlay network belong to the same administrative domain, then any messages routed between those nodes will only traverse other nodes belonging to the same administrative domain (e.g. xyz.com) of the larger underlying network (e.g., the Internet).

In one embodiment, the invention uses Scribe trees to construct a new tree called a Subscriber Volunteer (SV) tree. An SV tree is a multicast dissemination tree that allows nodes that do not wish to participate in disseminating messages (forwarding received messages to other nodes) to opt out. Thus, the tree is comprised only of nodes that subscribe to the messages and non-subscribing nodes that have volunteered to participate in message dissemination. The non-participating nodes may, for example, delegate their forwarding duties to other subscribers or volunteers in the tree. Participating nodes—i.e. subscribers and “volunteers” (non-subscribing nodes willing to participating in the routing of the messages)—may take on the message-forwarding duties of a node that does not wish to participate. This assumption of duties is made at the request of the node that wishes not to participate. In one embodiment of the invention, each participating node assumes the duties of at most one additional node, and hence the load on the participating node is at most its own load plus the load of the non-participant. In another embodiment of the invention, the forwarding duties of a particular node may be split among multiple other nodes, and the choice of this splitting may incorporate other factors, such as load-balancing based on node capabilities.

A further aspect of the invention uses multiple multicast dissemination trees for a single event topic to ensure reliable delivery of messages despite the existence of faulty or malicious nodes. These multiple multicast trees (herein referred to as “t-trees”) share subscriber nodes, but have different internal structures. Because the delivery path to each subscriber node varies in each of the t-trees, t-trees ensure reliable delivery of messages despite the existence of malicious or faulty nodes in the trees. The messages are delivered in parallel across the t-trees. Thus, even if a malicious node in one of the trees prevents the subscriber node from receiving a message in that tree, the node is still likely to receive the message through one of the other trees. To reduce message traffic, the primary tree transmits the whole message, whereas the secondary parallel trees transmit only a digest of the message. In this way, the invention leverages cheap memory and disk space (to store multiple redundant trees) to prevent malicious and faulty nodes from being able to disrupt delivery of event traffic.

When a subscriber node receives a message digest from a secondary tree but does not receive the actual message from the primary tree, the subscriber node requests that the root node of a secondary tree send the full message down the path of the tree connecting the subscriber node and the secondary tree root node. Each node in the tree has an indication of which nodes it is supposed to forward messages to.

In keeping with the invention, the multicast dissemination strategy switches between digest notifications and heartbeat messages, depending on the rate of message traffic. When message traffic on a topic is high, the root node of the primary tree tells the subscriber nodes to expect either an event message or a heartbeat message at every interval on the primary tree, and no traffic is sent on the backup trees. During high message traffic, the overhead of heartbeat messages is low. Subscriber nodes know that they are disconnected from the primary tree or that a malicious node has failed to correctly forward messages if they fail to receive an event or heartbeat message at the expected time. If this occurs, the subscriber knows to request missed messages on one of the backup trees. When message traffic is on a topic light, the root node tells subscriber nodes to look for event messages on the primary tree, and message digests on the backup trees. Thus, the nodes know that they are disconnected from the primary tree, or that a malicious node is preventing reception of messages from the primary tree, when they receive a digest message on a backup but no corresponding full message on the primary tree.

To enhance the security and reliability of message dissemination, tree construction pays attention to organizational boundaries, where an organization typically owns an administrative domain (e.g. XYZ Inc. owns xyz.com). In particular, trees are constructed so that messages are disseminated from the organization containing the root of the tree directly to each organization containing subscriber nodes, without crossing nodes in any third-party organizations. When a subscriber from a first organization wishes to subscribe to a tree rooted in a second organization (hereafter referred to as the root organization), the subscription request message may cross nodes in third party organizations. The subscription request message is passed through the first organization with each node checking to see if it is the last node in the first organization along the path to the root. When the subscription request reaches the last node in the first organization, that last node modifies the subscription message to indicate that topic messages should be forwarded directly to it by the first node in the root organization to receive the subscription message. The last node in the first organization then continues the forwarding of the subscription request towards a node belonging to the root organization. When a node belonging to the root organization receives the message, that node then sends the last node in the first organization a confirmation. If the last node does not receive the confirmation, then the last node picks a new node from its routing table (preferably to a different third party organization than the one it chose before) and repeats the process. Alternatively, a node may forward the subscription request message directly to a well-known node in the root organization if a registry of such well-known nodes is available.

Security is enhanced by adding certificate authorities to restrict the participation of malicious nodes in the multicast infrastructure. A global certificate authority is a trusted entity in the overlay network. An organization requests a certificate from the global certificate authority, certifying that the organization owns a particular administrative domain. After the global certificate authority verifies the ownership, it grants the organization a certificate of ownership and assigns the organization a batch of numeric IDs, which are assigned to nodes owned by the organization. Within each organization is an organizational certificate authority that assigns those numeric IDs to specific machines within the organization. The organizational certificate authority also certifies that nodes within the organization have valid node names.

Additional features and advantages of the invention will be made apparent from the following detailed description of illustrative embodiments which proceeds with reference to the accompanying figures.

### BRIEF DESCRIPTION OF THF DRAWINGS

While the appended claims set forth the features of the present invention with particularity, the invention, together with its objects and advantages, may be best understood from the following detailed description taken in conjunction with the accompanying drawings of which:

FIG. 1a is a block diagram generally illustrating an exemplary computer system on which the present invention resides;

FIG. 1b shows and example of a computer network in which the invention may be practiced;

FIG. 2a illustrates a possible node relationship in a multicast dissemination tree;

FIG. 2b illustrates data stored at each node of a multicast dissemination tree;

FIG. 2c illustrates a forwarding table stored at each node of a multicast dissemination tree;

FIG. 2d illustrates an example node name of a node in a multicast dissemination tree;

FIG. 3 illustrates nodes in an overlay network belonging to an organization, and a subset of nodes in an overlay network forming a multicast dissemination tree;

FIG. 4a depicts a node topology before a multicast tree is formed;

FIG. 4b depicts a node topology after a multicast tree is formed;

FIG. 5 illustrates a process performed by each node in the overlay network receiving a subscription message;

FIG. 6a illustrates an example Scribe tree;

FIG. 6b illustrates an example Subscriber Volunteer tree of the present invention;

FIG. 7 illustrates a plurality of parallel multicast dissemination trees sharing a common subscriber;

FIG. 8a illustrates the paths of full messages and digest messages down the branches of a plurality of parallel multicast dissemination trees;

FIG. 8b illustrates the path of a full message request message from a subscriber to the root node of one of a plurality of parallel multicast dissemination trees;

FIG. 8c illustrates the paths of full messages and digest messages down the branches of a plurality of parallel multicast dissemination trees after a full message request message has been received by a root node of one of a plurality of parallel multicast dissemination trees;

FIG. 9 illustrates nodes in an overlay network belonging to an organization, where each organization has an organizational certificate authority, and there is a global certificate authority in the overlay network hierarchically above the organizational certificate authorities.

### DETAILED DESCRIPTION OF THE INVENTION

Turning to the drawings, wherein like reference numerals refer to like elements, the invention is illustrated as being implemented in a suitable computing environment. Although not required, the invention will be described in the general context of computer-executable instructions, such as program modules, being executed by a personal computer. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multi-processor systems, microprocessor based or programmable consumer electronics, network PCs, minicomputers, mainframe computers, and the like. The invention may also be practiced in distributed computing environments where tasks are performed by remote processing devices that are linked through a communications network. In a distributed computing environment, program modules may be located in both local and remote memory storage devices.

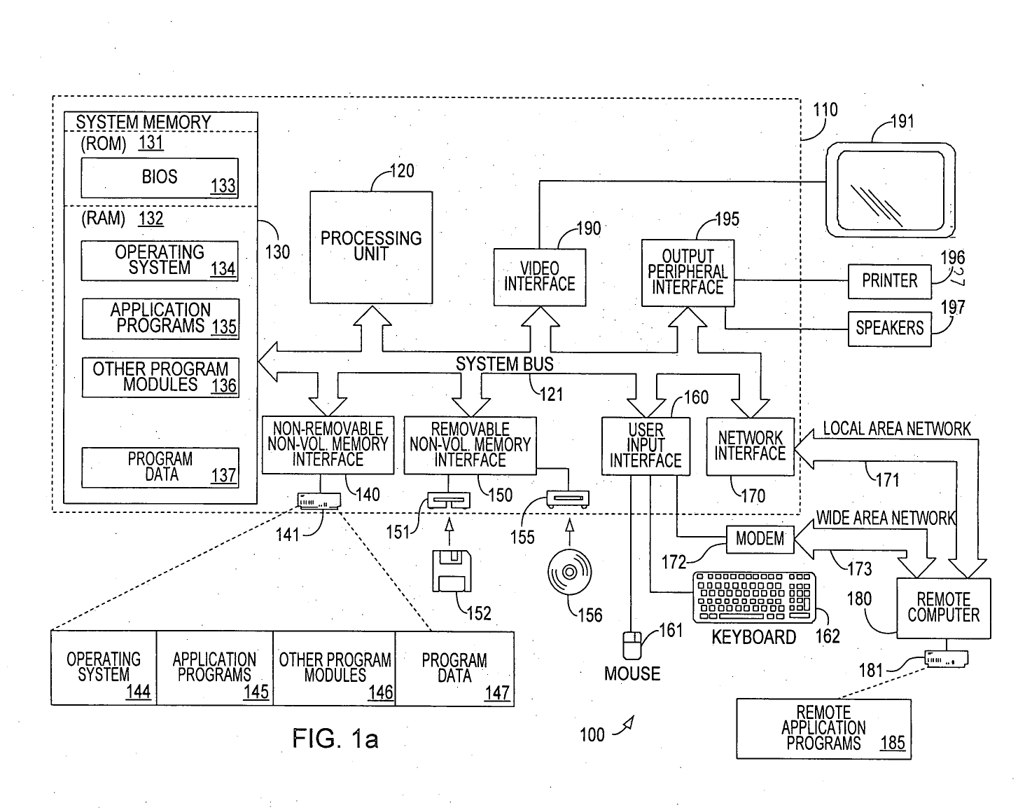

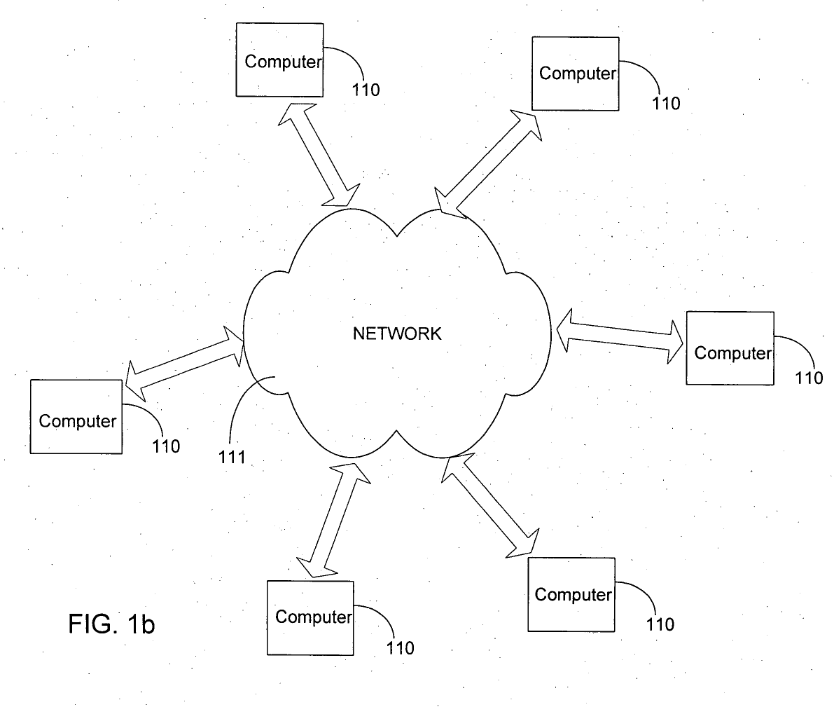

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Associate (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers hereto illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be another personal computer, a server, a router, a network PC, a peer device or other common network node, and typically includes many or all of the elements described above relative to the personal computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the personal computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the personal computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

An example of a networked environment in which the invention may be used will now be described with reference to FIG. 1B. The example network includes several computers 110 communicating with one another over a network 111, represented by a cloud. Network 111 may include many well-known components, such as routers, gateways, hubs, etc. and allows the computers 110 to communicate via wired and/or wireless media. When interacting with one another over the network 111, one or more of the computers may act as clients, servers or peers with respect to other computers. Accordingly, the various embodiments of the invention may be practiced on clients, servers, peers or combinations thereof, even though specific examples contained herein do not refer to all of these types of computers.

In the description that follows, the invention will be described with reference to acts and symbolic representations of operations that are performed by one or more computer, unless indicated otherwise. As such, it will be understood that such acts and operations, which are at times referred to as being computer-executed, include the manipulation by the processing unit of the computer of electrical signals representing data in a structured form. This manipulation transforms the data or maintains it at locations in the memory system of the computer, which reconfigures or otherwise alters the operation of the computer in a manner well understood by those skilled in the art. The data structures where data is maintained are physical locations of the memory that have particular properties defined by the format of the data. However, while the invention is being described in the foregoing context, it is not meant to be limiting as those of skill in the art will appreciate that various of the acts and operation described hereinafter may also be implemented in hardware.

The present invention provides an event notification service that operates as a peer-to-peer messaging system. A method for multicasting messages on a computer network is described in commonly assigned U.S. patent application Ser. No. 10/177,335, which is hereby incorporated by reference in its entirety. Event notification is provided for topics, where each topic is basically a multicast group comprising a group of computers 110 in the peer-to-peer network subscribing to the topic. The invention supplies an event notification infrastructure that supports the entire spectrum of event topics, from small, local event topics that disseminate information within a region such as a building or campus, to large, global event topics that disseminate information to a large number of subscribers. The event notification message can be embodied in a standard XML data structure, and transmitted in a User Datagram Protocol (UDP) packet or Transmission Control Protocol (TCP) stream. The invention is particularly suited for supporting applications such as instant messaging and alerts.

The programming model of the present invention supports the following method calls:
Create: Request the creation of a new, unique, named event topic.
Subscribe: Request to henceforth receive all event notification messages published to a given event topic. A request can also specify that all recently past event notifications should be returned immediately. The requestor will receive all such notifications still stored by the system.
Publish: Send an event notification message to an event topic. A copy of this message will be delivered to every currently subscribed, currently reachable client of the event topic.
Unsubscribe: A subscribed client can request to stop receiving event notifications for an event topic.

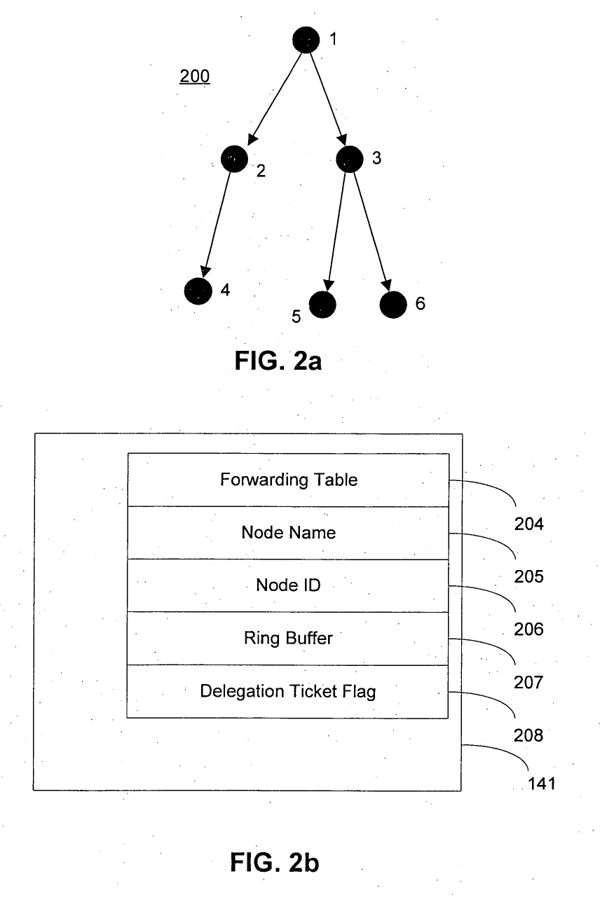

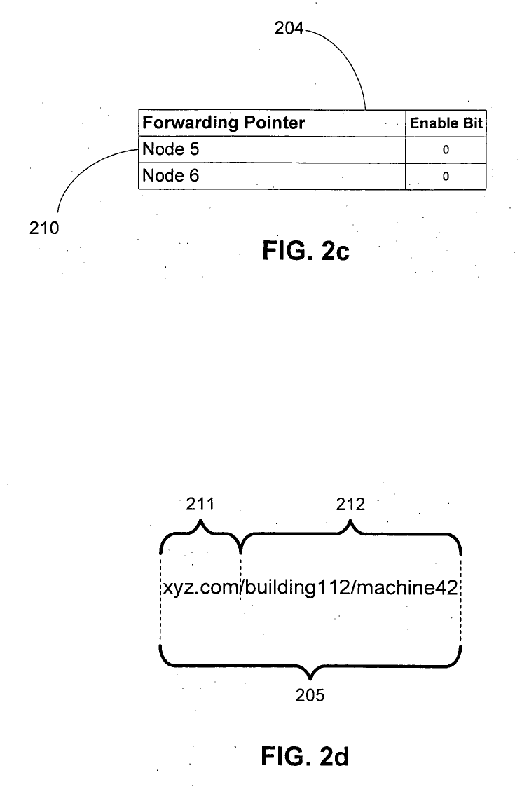

Messages are delivered to subscribers by means of a multicast dissemination tree. In a multicast dissemination tree, multicast group members are responsible for forwarding multicast messages to other members of the group. Each computer 110 in the multicast group is said to be a node in the multicast dissemination tree and is herein referred to as a “node.” FIG. 2a depicts a multicast dissemination tree 200 comprising a root node, intermediate nodes, and leaf nodes, wherein Node 1 is the root node, Nodes 2 and 3 are intermediate nodes, and Nodes 4-6 are leaf nodes. Nodes in the multicast dissemination tree receive messages from their parent nodes, and are responsible for forwarding the messages to their child nodes. For example, in FIG. 2a Node 3 receives messages from Node 1 and forwards those messages to its children, Nodes 5 and 6.

FIG. 2b shows that each node in a multicast dissemination tree has data stored in a memory, e.g. memory 141 in FIG. 1a, including a forwarding table 204. Other stored data includes a node name 205, a node ID 206, a ring buffer 207, a delegation ticket flag 208, and an enable bit 209 (FIG. 2c), to be discussed later. The forwarding table 204 maintains the list of forwarding pointers 210 that point to that node's child nodes. Thus, each node in a multicast dissemination tree forwards a received message to those nodes pointed to in its forwarding table 204. For example, FIG. 2b shows the forwarding table 204 for Node 3, wherein the forwarding table 204 contains forwarding pointers to Nodes 5 and 6.

The invention employs an overlay network to route messages between nodes. SkipNet (See commonly assigned U.S. patent application Ser. No. 10/356,961, which is hereby incorporated by reference in its entirety) is an overlay network that considers locality in its infrastructure. In addition to a numeric ID, SkipNet assigns a string name to each node in the overlay network. String names can encode an administrative domain to which the node belongs (e.g. ford.com) and SkipNet can route messages in a manner that ensures they only go through nodes that share the same string prefix as the initial source and final destination nodes of a message. The organizational names at the nodes in the SkipNet overlay network ensure path locality i.e., an overlay routing path between overlay nodes traverses only nodes belonging to the same administrative domain.

A multicast infrastructure utilizing SkipNet's path locality features does not currently exist. For example, the Scribe multicasting infrastructure does not provide a facility for constraining multicast dissemination trees to a specific administrative domain. Such multicast infrastructures are open to attack by a malicious organization, if the multicast dissemination tree depends on the malicious organization for relaying messages. Though multicast dissemination trees will inevitably sometimes encompass nodes of only one organization, the existing multicast infrastructures cannot guarantee that a multicast dissemination tree will only encompass nodes from a single organization. Thus, a new multicast infrastructure is needed to utilize the locality features offered by overlay networks such as SkipNet. One embodiment of the invention uses SkipNet as the structured overlay network, which supports path locality. Path locality refers to the ability to guarantee that the routing path between any two nodes in a particular region of the network does not leave that network region. The network region may be a building, an administrative domain, a geographic location, etc. Using the example above, XYZ Inc. may desire to restrict sensitive messages from being routed outside the xyz.com domain. Using path locality, a message from UserA (usera@xyz.com) to UserB (userb@xyz.com) is restricted such that it is only routed across computers in the xyz.com domain. This may be of particular importance if some of the other domains on the overlay network belong to competitors of XYZ Inc. Other overlay networks may be used if they provide the path locality feature. Each node in the overlay network must maintain a routing table containing the node name 205 and IP address of a subset of nodes in the overlay network.

In the context of this invention, network regions are owned by organizations. The organization owning the network region controls access to the network region. For example, an organization owning building A controls whether machine X in building A has access to the network in building A. Alternatively, the organization owning xyz.com controls whether UserA can use the address UserA@xyz.com. Therefore, the organization owning the network region in which a computer is located is said to own that computer.

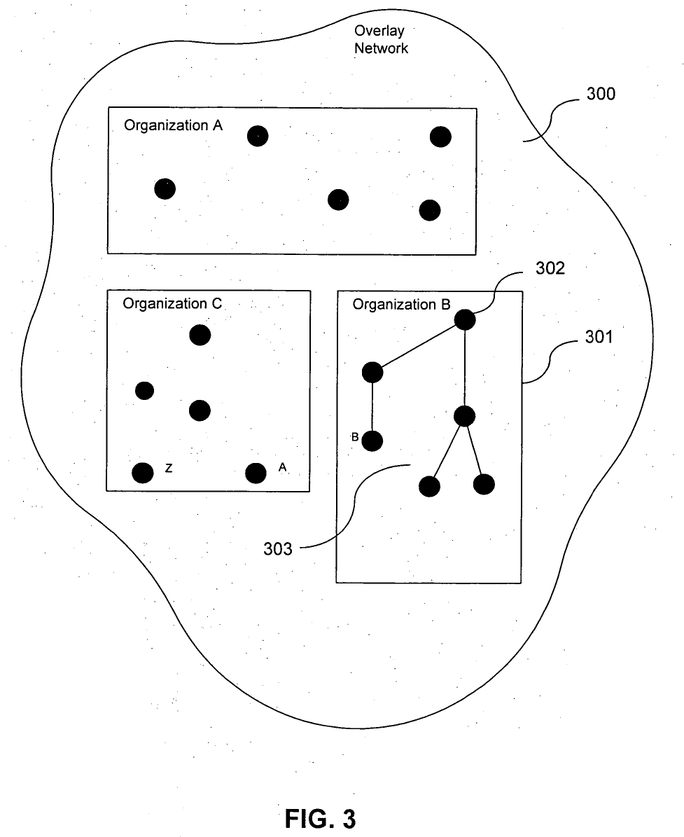

In accordance with the first embodiment, FIG. 3 depicts a set of nodes in an overlay network 300 divided into network regions, where an organization owns each network region. The multicast tree 303 includes a subset of nodes in the overlay network, wherein each node in the multicast tree 303 is located in network region 301 owned by Organization B. Because the root node 302 of multicast tree 303 is located in a network region 301 owned by Organization B, Organization B is said to own the multicast tree 303. Furthermore, each node in the overlay network 300 has a node name 205. FIG. 2d shows that a node name 205 comprises an organizational prefix 211 and an organization-relative suffix 212. The organization-relative suffix 212 can encode a geographic locality within an organization, thereby constraining the multicast dissemination tree to a network region within the network region of the organization.

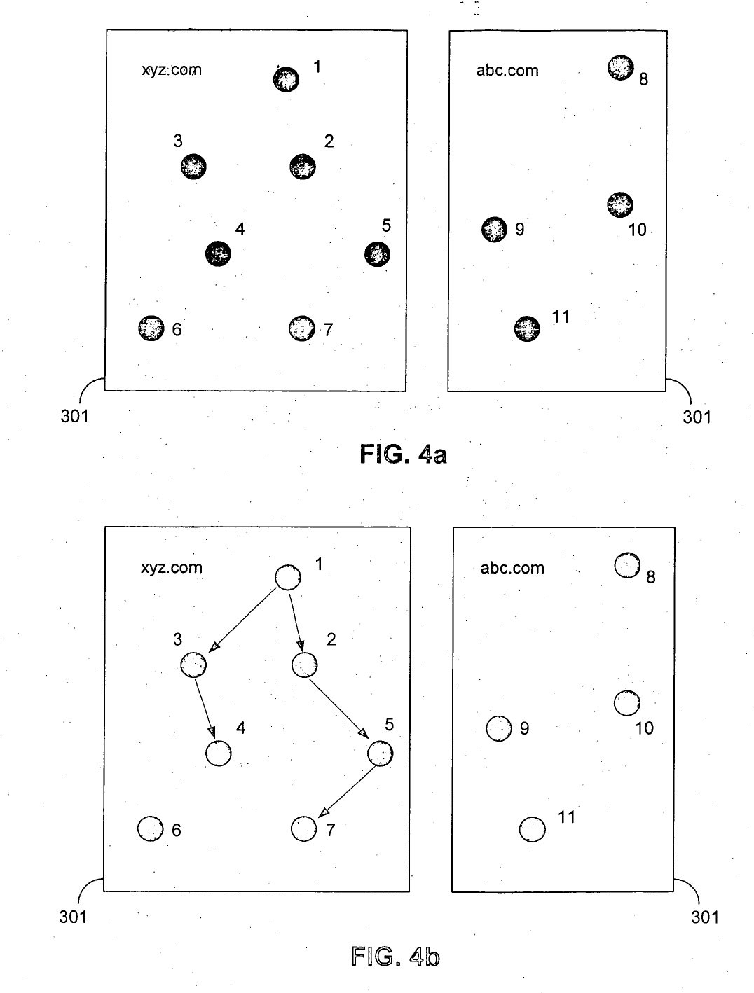

An embodiment of the invention provides a feature that prohibits nodes in a multicast tree owned by a first organization from depending on nodes owned by a second organization to forward message traffic from other first organization nodes. The invention achieves this prohibition using the path locality features of the overlay network to require that intermediate nodes in a path from a subscriber node to the root node of the multicast tree forward subscription messages only to nodes belonging to the same organization as the subscriber and root node. For example, FIG. 4a illustrates a set of overlays nodes 1-7 belonging to XYZ Inc. and a set of overlay nodes 8-11 belonging to ABC Inc. Each overlay node is located in the administrative domain associated with their organization, e.g. xyz.com, and has been assigned a node name 205 with the appropriate organizational indicator 211 and organization-relative indicator 212, e.g. xyz.com/node5.

A method of forming a multicast tree proceeds when a node wanting to join the tree (i.e. receive messages from the root node) sends a subscription message to the root node of the tree. In FIG. 4a, assume that node 1 is designated as the root node and node 7 wants to receive messages from node 1. Node 7 generates a subscription message, identifies which node in its routing table is in xyz.com and closest to the root node 1, and sends the subscription message to that node indicating that it is to be forwarded to the root node 1. In this case, node 7 sends the subscription message to node 5, which node 7 can identify as belonging to xyz.com because of node 5's node name, xyz.com/node5, recorded in node 7's routing table.

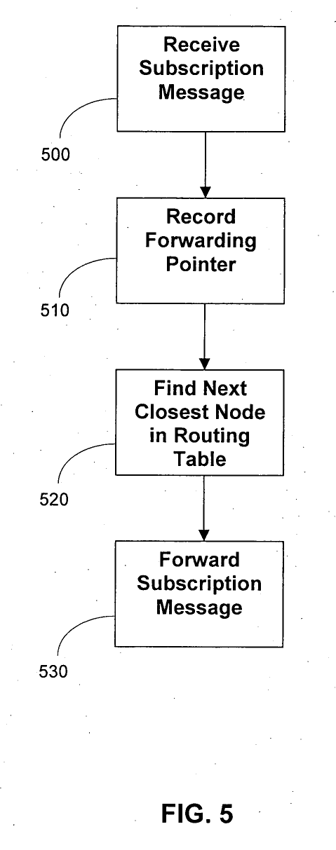

FIG. 5 depicts the steps taken at each intermediate node in the routing path between the subscriber and the root node. At step 500, a node receives the subscription message from a preceding node. For example, node 5 receives the subscription message sent by node 7. At step 510, the node receiving the subscription message records a forwarding pointer 210 to the node that sent the message, indicating that the receiving node is to forward messages to the sending node. At step 520, the receiving node identifies a node in its routing table that is closer to the intended recipient, root node 1, and belongs to same organization. For example, node 5 finds node 2 in its routing table, node 2 being closer to the root node 1 and belonging to xyz.com. Note, in no case would node 5 route the message to node 9 because node 9's node name, abc.com/node9, indicates that it does not belong to the same organization as node 5. At step 530, the receiving node forwards the subscription message to the identified node. In this case, node 5 forwards the subscription message to node 2. Node 2 repeats the process, forwarding the subscription message to root node 1. Root node 1 records a forwarding pointer to node 2, and the result is a multicast tree with only one path, i.e. the forwarding pointer path from root node 1 to node 2 to node 5 to node 7.

If node 4 also subscribes to the multicast tree by the same process, an example of the tree would appear as depicted in FIG. 4b. If node 6 also wishes to subscribe to the multicast tree, node 6 would send a subscription message to root node 1 via node 4. Instead of the previous process, node 4 will not forward the message to root node 1 because node 4 is already a member of the tree, thus there is already a forwarding path from root node 1 to node 4. Node 4 simply records a forwarding pointer to node 6, and does not forward the subscription message. As new nodes subscribe to the topic, the multicast tree comprises the union of all paths between the root node and all subscriber nodes.

As another feature of the invention, the invention can further constrain the multicast tree by using the organizational-relative suffix 212 to require that, when a subscriber node and the root node are located in the same geographic locality within the organization, all nodes in a path between the subscriber node and the root node are also located in the same geographic locality.

Accordingly, multicast trees are formed while guaranteeing that nodes belonging to the same organization do not depend on an external intermediate node to route messages between them. Using the node name 205 with the organizational indicator 211, the invention restricts the overlay routing of subscription messages to nodes having the same organizational indicator. Thus, if an event topic is used primarily by subscribers within a single organization, then the present invention can ensure that the subscribers to the topic not depend on nodes that are outside the organization. Note that an event topic created within an organization is still visible to nodes outside the organization if the topic is registered with a globally accessible name server. One such name service is the Overlook name service described in commonly assigned U.S. patent application Ser. No. 10/107,287, which is hereby incorporated by reference in its entirety.

Therefore the present invention provides support for network region disconnect. Should a network region of the overlay network become disconnected from the rest of the system, the multicast trees within the disconnected region will continue to route messages correctly and efficiently within that region. The net result is that “local” event topics can be made to only depend on the system resources of a local network region, and can thus be made immune to the vagaries of network and node failures that occur external to the network region. The locality scope to which an event topic should be constrained—i.e. over which topic root node placement will be performed—is specified by the creator of the topic.

When a topic is created, the topic creator selects a plurality of nodes to be root nodes of multicast trees, wherein the root nodes are distributed throughout a network region (if the topic is local), or throughout the entire overlay network (if the topic is global). The root nodes form the roots of the multiple trees in the t-trees aspect of the invention. The topic and associated root nodes are registered in a name service so that nodes wishing to subscribe to the topic may locate all the root nodes. Nodes wishing to subscribe find the address of the root nodes using a name service and send subscription messages to them as previously described. Messages about the topic are published to each root node associated with the topic. Each root node then forwards the message to each subscriber through its multicast tree using the t-trees strategy of switching between heartbeats and digests.

In another embodiment of the invention, an external node belonging to a second organization joins the multicast tree owned by a first organization. Turning to FIG. 3, when an external client, e.g. Node Z, sends a subscription request message towards a multicast tree root node in Organization B, each intermediate node checks to see if the next routing hop is to a node in a different organization from the subscriber's organization. Suppose that Node A is the last forwarding node in a subscriber's organization. Node A modifies the subscription request to indicate that it wants the first intermediate node that belongs to the organization owning the tree, e.g. Node B, to forward event messages directly to it. Node B sends Node A a confirmation message directly using the underlying network routing layer (e.g. IP routing) to avoid potential overlay routing hops through other organizations. Node A verifies the authenticity of the confirmation message because the identity of the organization owning the tree is known from the tree's name and the validity of a node's membership in an organization can be determined from security certificates that it must include in its messages. Cryptographic techniques can be used to ensure that the request message isn't tampered with.

If Node A does not receive a confirmation reply then it assumes that some malicious node has dropped its subscription request. It must therefore find some other path through the overlay that doesn't include a malicious node in order to be able to connect to a node in the organization owning the tree. Node A picks a random entry from its routing table and sends the indicated node the subscription request. That node will forward the message in the usual manner, causing it to take a different overlay routing path than the one taken by Node A's original attempt to forward the subscription message. If Node A continues to not receive a confirmation message then it tries again. It does so until it succeeds or tried some pre-determined number of times, in which case it will send an error message back to the subscribing client.

Alternatively, when an external client wishes to subscribe to a topic owned by another organization, e.g. Organization B, the client sends a subscription request to a well-known node in Organization B. The client can determine the IP address of the well-known node using a name service, and send the subscription request message using the network routing layer underlying the overlay network. The name service records one or several “well-known” nodes for each organization. The subscription request message is not modified, and is forwarded directly to Node B.

To be able to handle subscribers who request past event notification messages, the invention specifies that each forwarding node of a tree keep a ring buffer 207 of recent event messages. This ring buffer 207 may be any memory within the node that stores event messages while preserving their order, or storing the date and time that the message was broadcast or received. Accordingly, the invention handles the common case of a subscriber who becomes temporarily disconnected from an event topic and then resubscribes to it and wants to know what events have been missed. By keeping a ring buffer at each tree node the node is able to field requests for event histories in a scalable manner.

In accordance with a further embodiment of the invention, the invention employs a novel multicast tree called a Subscriber Volunteer (SV) tree. An SV tree is derived from the Scribe tree of Rowstron et al., but does not require nodes to forward message traffic unless they are a subscriber, or a willing volunteer. The structure of a Scribe tree will first be described.

Scribe tree construction is done by means of a technique, called “reverse path forwarding.” A particular node in the overlay network is chosen to be the root node of the tree. Clients wishing to join the tree learn of the identity of this root node—for example, by looking it up in a name service—and route a subscription message through the overlay network to the root node. At each intermediate overlay node encountered by the message, a forwarding pointer 210 is recorded in the forwarding table 204 to point to the overlay node from which the message just came. The result is a dissemination path from the root node to the subscriber node. The Scribe tree is the union of the paths to all subscriber nodes.

As an optimization, when a subscription message encounters a node at which there are already other forwarding pointers for its tree then there is no need for the message to be routed any further. This is because the necessary tree forwarding pointers between the current location and the tree root node have already been created by previous subscription requests.

When a node in a Scribe tree discovers that it has become disconnected from its parent node (for example, because the parent node has crashed) it reconnects to the tree by simply sending out a new subscription message. This will result in the node being reattached to the tree at some other point. When the root node of a tree fails, its children will eventually detect the failure and then issue re-subscription requests as previously described. The routing semantics of the overlay network will result in all these subscription messages being sent to that overlay node whose identifier is adjacent to the identifier of the (failed) tree root node. That node will, by default, become the new root node for the tree.

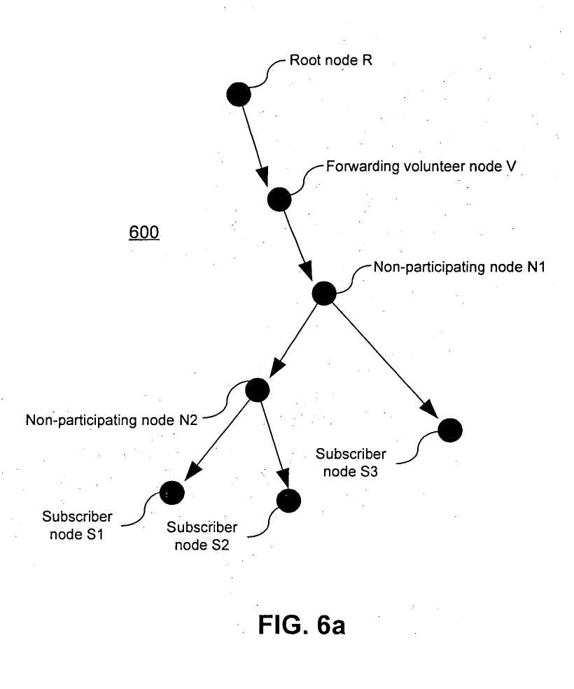

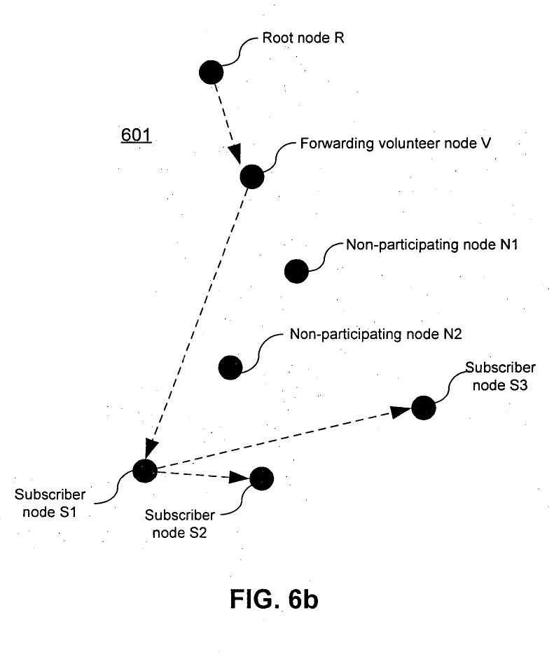

Scribe trees require the participation of nodes that did not subscribe to an event topic if those nodes happen to be on the overlay routing path between a subscriber and the root of the tree. For example, FIG. 6a shows a Scribe tree where subscriber S1's overlay routing path to the root node R of Scribe tree 600 includes nodes non-participating node N2, non-participating node N1, and forwarding volunteer node V1. While some nodes, such as forwarding volunteer node V1, might be willing to donate resources to forwarding the traffic of Scribe tree 600, others, such as non-participating nodes N1 and N2, might not.

The present invention derives an SV tree from each Scribe tree it employs. This tree is comprised of all the subscriber and “volunteer” forwarding nodes in the Scribe tree. In FIG. 6b the SV tree 601 contains root node R, volunteer node V1, and subscriber nodes S1, S2, and S3. The second embodiment of the invention employs both a Scribe tree and an associated SV tree to implement each multicast tree that it creates. The Scribe tree is the result of subscription messages that are routed by newly-subscribing overlay nodes towards the root node of a multicast tree. The Scribe tree provides a scalable way for clients to join a multicast tree. The associated SV tree is used to actually disseminate event notification messages. The SV tree provides a scalable way to forward event traffic that employs only willing participants.

An SV tree is constructed by having nodes from the associated Scribe tree that do not wish to participate in forwarding event traffic delegate their forwarding duties to some descendant node that is willing to do so. The subscribers and volunteers in a Scribe tree are referred to as “participants,” and the remaining Scribe tree nodes as “non-participants.” For example, in FIG. 6b, non-participating node N1 delegates its forwarding duties to participating subscriber node S1, who is then responsible for forwarding event traffic to subscriber nodes S2 and S3. After SV tree construction, non-participating node N2 has no forwarding responsibilities.

SV trees are implemented by having each participant node generate a unique delegation ticket including a pointer to itself. Each non-participant node tries to obtain a delegation ticket from one of its descendant nodes in the Scribe tree. The creator of a delegation ticket is responsible for the message forwarding duties of the holder of the ticket. Upon obtaining a delegation ticket, a non-participant node must inform its Scribe tree parent node of the delegation and inform the delegation ticket creator of its new forwarding duties. If the parent node is also a non-participant, and the parent node lacks a delegation ticket, then the delegation ticket is passed to the parent.

Each participating node stores a delegation ticket flag 208 indicating whether the node has given away its delegation ticket. The delegation ticket is passed to a non-participating node in a message. When a parent node is informed by a non-participating child node that the non-participating node has obtained a delegation ticket, and the parent does not usurp the delegation ticket, the parent node updates its forwarding table 204 with the forwarding pointer 210 indicated by the delegation ticket. When a delegation ticket is obtained from a descendant node (i.e. a child node, a grandchild node, a great-grandchild node, etc.), the delegation ticket flag is set, and the delegation ticket passer updates its forwarding table 204 with the forwarding pointers 210 stored in the delegation ticket receiver's forwarding table 204.

For example, in FIG. 6a non-participating node N2 obtains a delegation ticket from its child subscriber node S1 (it could also have chosen subscriber node S2). Since non-participating node N1 is also a non-participant, it obtains a delegation ticket from its child node non-participating node N2 (it could have also been obtained from subscriber node S3). Now non-participating node N2 must obtain a new delegation ticket, and it takes it from child node subscriber node S2. Non-participating node N1 then informs volunteer node V1 that subscriber node S1 is non-participating node N1's forwarding delegate, and non-participating node N2 informs non-participating node N1 that subscriber node S2 is non-participating node N2's forwarding delegate. Non-participating node N1 then tells subscriber node S1 to forward traffic to both subscriber node S3, its child in the Scribe tree, and subscriber node S2, its Scribe tree child's forwarding delegate. Because non-participating node N2's Scribe tree children have passed their delegation tickets up the tree, non-participating node N2's delegate does not need to forward any traffic. The result is the SV tree depicted in FIG. 6b. Because each participant only gives out a single delegation ticket, the load on a participant is at most its original Scribe tree load plus the load of one non-participant.

Another embodiment of the invention is directed to the construction of SV trees without the use of delegation tickets. This embodiment is described by explaining the subscription message processing that occurs when a new subscriber client wishes to subscribe to a topic. The subscribing node sends a subscription message towards the root of the topic they wish to subscribe to through the overlay network. This message is a one-way message, not a remote procedure call (RPC)-style message. The client retransmits the message after some period of time if it has not successfully subscribed to the topic by joining the SV tree for that topic.

A failure notification service is used to notice failures related to maintaining a subscribed status. A failure notification service that has particular applicability to the methods of the present invention is described in co-pending, commonly assigned U.S. patent application Ser. No. ______, Attorney Docket No. 224487, which is hereby incorporated by reference in its entirety. The failure notification service is installed on each node in the overlay network, and is used to create a failure notification group that includes overlay nodes. An application creates a failure notification group by calling a “create” function of the failure notification service and passing to it a set of nodes to be included in the group. The failure notification service returns a unique identifier for the group. The application then sends the group ID to the other nodes in the failure notification group, who each associate a failure handling method with that group ID.

When the failure notification service running on failure notification group members ascertains a failure affecting the group, it executes the failure handling method associated with the group ID and signals a failure notification to the other group members. The failure notification may be signaled either explicitly by a message or implicitly by not responding to communication from the other group members, thus causing those members to also ascertain a failure. The present invention is not limited to the failure notification service described above, but does require that the failure notification service provide for the formation of a failure notification group, the association of failure handlers with that group, and the ability to signal failure notifications to other group members.

Subscription message processing will now be described. The subscription message is routed through the overlay network until it encounters a node that is already part of the Scribe tree for the current topic. As in the standard construction of a Scribe reverse path forwarding tree, the message drops a Scribe link forwarding pointer at each intermediate node, and at the first node it encounters that is already part of the Scribe tree. When the message reaches a node that is already part of the Scribe tree, there are three cases to consider as to where the subscribing node will attach to the SV tree:

1) The current Scribe tree node is also an SV tree node. In this case this node is designated as the attachment node. This is done by sending an “SV-probe” message directly to the subscribing client. The SV-probe message indicates that the sender is a candidate attachment point to the SV tree. The client will react to this message by sending an “SV-attach” message back to the current node. The SV-attach message is described later.

2) The current Scribe tree node is not an SV tree node and has not yet pushed responsibility for any forwarding pointer to its Scribe parent node. In this case the forwarding pointer is conceptually pushed up to the Scribe tree parent node by having the subscription message continue to be routed towards the topic's root node. This effectively delegates responsibility for the forwarding pointer to the current node's Scribe tree parent. A state is set on the current node indicating that it has pushed responsibility for a forwarding pointer to its Scribe tree parent. The subscription message then continues up the Scribe tree until an SV tree node is found.

3) The current Scribe tree node is not an SV tree node and has pushed responsibility for some forwarding pointer to its Scribe tree parent node. In this case the responsibility for the forwarding pointer is pushed to a Scribe child node of the current node. This is done by sending an SV-probe message down to each eligible Scribe tree child node. Which child nodes are eligible is explained below.

In order to prevent cycles from being created in an SV tree the invention restricts to where SV forwarding pointers can be pushed. Pushing a pointer to a Scribe tree parent node will never cause a forwarding pointer cycle to occur. To prevent cycles from occurring when forwarding pointers are pushed to Scribe tree child nodes, the invention imposes a partial ordering on the Scribe tree child nodes of a given Scribe node. Once a subscription message coming up from one (possibly new) Scribe tree child node has its associated forwarding pointer pushed down another Scribe child node's subtree, forwarding pointers are never allowed to be pushed “in the opposite direction”. The implementation of this restriction is explained.

Each Scribe tree node maintains a hash table with entries for each of its Scribe tree child nodes. When a subscription message arrives at a node, it will have come from a (possibly new) Scribe tree child node—call it A. If the associated forwarding pointer (which points at the client who initiated the subscription message) is eventually pushed down the Scribe subtree rooted at another Scribe child node—call it B—of the current node, then the hash table entry for B is updated to contain A. This signifies that forwarding pointers associated with subscription messages coming from B should henceforth never be pushed down the Scribe subtree rooted at A.

When creating an eligible set of child nodes to which a forwarding pointer may potentially be pushed down, the invention calculates the transitive closure of the data in the hash table to determine to which nodes the pointer may not be pushed. Thus, a forwarding pointer coming up through B would cause a lookup of B's hash table entry, which would yield A (and possibly other nodes). A look up A's hash table entry then yields an additional set of nodes to which a forwarding pointer may not be pushed. An “exclusion list” is formed by taking all the hash table entries that are looked up, looking up each entry in turn, and doing so until no more new entries to add to the exclusion list are produced. The eligible set of Scribe tree child nodes consists of all children minus those in the exclusion list.

Hash table entries get updated when an SV-attach message arrives at a Scribe tree node telling it of where an SV tree forwarding pointer was actually attached that was originally pushed down by the current node. Entries in the hash table get removed when a Scribe tree child node notices that it no longer has any children of its own. When it notices this it sends a notification message to its parent node telling the node that it can deallocate the state it is keeping for that child node; i.e. it effectively tells the parent that it is leaving the Scribe tree.

When the Scribe tree child node receives an SV-probe message it checks to see if it is either a member of the topic SV-tree or is a subscriber to the topic (and hence will eventually be connected to the SV-tree once it's own concurrently advancing subscription request gets processed). If it is, then it forwards the SV-probe message directly to the subscribing client node, thereby indicating that it is a candidate attachment point for SV-tree attachment. If it isn't, then it randomly picks a Scribe child node and forwards the SV-probe message onward to that child node.

When a subscribing client node receives the SV-probe message, if the client node is already attached to the SV tree then it simply discards the SV-probe message. If the subscribing client node has not yet attached to the SV tree, it tries to attach to the SV tree node from which the SV-probe was sent. The first thing the subscribing node does is create a failure notification group using the failure notification service describe above. The failure notification group contains all the nodes in the overlay path traversed by the subscription messages and all the nodes in the overlay path traversed by the SV-probe message. Once this failure notification group has been successfully created, an “SV-attach” message is sent out that retraces the same path. The SV-attach message informs each node that it traverses of the failure notification group ID that has been created for the subscription and also of the actions that node should take if the failure notification group should ever signal failure. The SV-attach message also installs an SV tree forwarding pointer to the subscriber node on the final node in the path, which is the node that sent the SV-probe message back to the original subscriber node. The final node associates a failure handling method with the failure notification group using the failure notification service on that node. The failure handling method removes the SV tree forwarding pointer to the subscriber node if a failure notification is signaled for that group.

Furthermore, the SV-attach message installs an update to the table used by Scribe tree nodes to determine which Scribe child nodes are eligible for pushing a forwarding pointer to on the node from which the SV-probe message originated (i.e. the node at which the subscribe message stopped, which is the first node in the Scribe tree that the subscribe message encountered). If this update is found to be invalid (because it causes a cycle in the partial order), the failure notification group is signaled and the subscribing node must start from scratch.

There are two different kinds of failure notification groups created as part of SV tree subscription. Each link in the Scribe tree associated with an SV tree has a failure notification group that monitors its liveness. Each subscription to the SV tree has a failure notification group that is used to garbage collect the associated SV tree forwarding pointer and eligible candidates table information.

Each Scribe tree forwarding pointer is checked for liveness via a separate failure notification group that is created at the same time as the forwarding pointer is installed. When a node belonging to a Scribe tree fails, its parent node in the Scribe tree will be notified by a failure notification group failure signal. The parent node simply removes the Scribe tree link information for the failed child from its records. All the Scribe child nodes of the failed node will also be notified of the failure by the relevant failure notification groups monitoring their links to the failed node. These child nodes will initiate Scribe tree resubscription (described later) to rejoin the Scribe subtree rooted at them to the Scribe tree as a whole.

When any node on the path taken by a subscription and subsequent associated SV-probe message fails, the failure will cause the failure notification group monitoring all those nodes to signal failure to each node on the path. The node at which the associated SV tree forwarding pointer exists will discard that pointer. The node at which the eligible candidates table information corresponding to that forwarding pointer was installed—i.e. the node at which the subscribe message stopped and an SV-probe message was initiated—removes the associated eligible candidates information from its table. All the other nodes on the path do nothing when they receive the failure signal. The failure notification group for a subscription path also includes the subscriber node itself. When that node receives a failure signal, it resubscribes by sending out a new subscription message.

When a Scribe tree link is broken, the child node resubscribes to the Scribe tree by routing a Scribe-subscribe message towards the root of the topic through the overlay network (as with the regular subscription message for SV tree subscription). This message drops Scribe links and creates associated failure notification groups until it encounters a node that is already part of the Scribe tree. Then it stops.

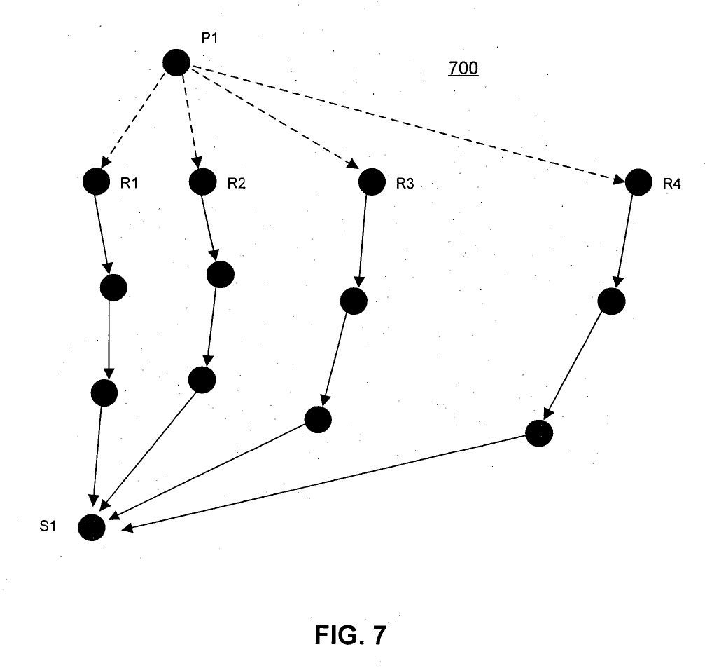

A further embodiment of the invention employs multiple multicast trees to ensure reliable delivery of event notification messages in the face of both failed and malicious multicast tree nodes. In accordance with the third embodiment, FIG. 7 depicts a plurality of parallel multicast trees. Primary multicast tree T1 includes root node R1 and subscriber S1. Secondary multicast tree T2 includes root node R2 and subscriber S1. Secondary multicast tree T3 includes root node R3 and subscriber S1. Secondary multicast tree T4 includes root node R4 and subscriber S1. Publisher P1 sends event notification messages to each multicast tree T1-4 in parallel, and each tree delivers those messages to subscriber S1 in parallel. Thus, if there is a malicious node in primary multicast tree T1 preventing delivery to a subscriber, delivery may still occur through a parallel secondary multicast tree sharing the same subscriber. Because the cost of maintaining parallel trees is only the memory space used to implement the tree, reliable delivery can be ensured without the high cost of maintaining the tree through heartbeat messages. In one embodiment, every subscriber in the primary multicast tree T1 is also in each secondary multicast tree T2-4.

The number of trees to use depends on the number of faulty or malicious nodes a topic wants to be able to survive. If node failures are independent of each other and if malicious nodes cannot assume arbitrary identities or subvert other nodes' overlay routing decisions—which would allow them to become forwarding nodes in a tree—then the number of trees, t, needed to achieve reliable delivery can be relatively small. Indeed, the total number of faulty or malicious nodes in the system can be considerably larger than t, as long as the probability that more than t such nodes will be able to affect the tree paths leading to any given subscriber is acceptably small. The overhead of employing multiple trees in parallel is reduced by sending “digest” messages instead of full messages along secondary multicast trees. Furthermore, digest messages may cover multiple full messages, thereby reducing the replicated delivery overhead even further in exchange for imposing somewhat longer periods of time during which a subscriber may be unaware of having missed a message.

Sometimes topics will be very active for a period of time, and then go latent for a period of time. During periods when event notification traffic is high, it may be unnecessary to utilize multiple parallel multicast trees because the traditional heartbeat method of ensuring reliability can be used. That is, during periods of high traffic, failures may be detected if the node can expect to receive either an event notification or a heartbeat message at a predetermined interval. Accordingly, the present invention contemplates the use of two methods to ensure reliable delivery of event notifications.

When message traffic is high, the nodes in the multicast tree are informed to expect either an event notification message or a heartbeat message at a predetermined interval to be delivered on the primary tree. If a node fails to receive an event notification or heartbeat message within the predetermined interval, that node attempts to reconnect to the tree by re-subscribing, or it explicitly requests delivery of this missing messages using one of the secondary trees. When message traffic is low, the nodes in the multicast tree are informed not to expect an event notification or heartbeat message at a predetermined interval. Instead, multiple parallel multicast trees are utilized and event notifications are broadcast in parallel to ensure delivery.

The ability of parallel multicast trees to successfully deliver event messages depends on the path to any given subscriber in each tree being disjoint from the path to that subscriber in every other tree. The likelihood of this being true depends on how closely spaced tree root nodes are to each other: root nodes that are situated near each other in the overlay network will likely result in multicast trees whose paths to any given subscriber will share many nodes, whereas root nodes that are far apart will likely result in multicast trees whose paths have little overlap. Unfortunately placing tree root nodes far apart is in contradiction to the present invention's goal of keeping event topics local to the regions and organizations that they are used in.

The present invention addresses this tradeoff by placing the root node of the primary multicast tree for an event topic local to the region that the event topic is intended to cover (as specified by the topic's creator). The remaining tree root nodes are placed at exponentially increasing distances in the overlay network from the primary root node. For example, FIG. 7. shows root nodes R2-4 placed at exponentially increasing distances from root R1. The net result is that each individual tree provides a different trade-off between the amount of locality it provides and the amount of separation it provides. Partition of a region away from the rest of the system will likely still leave some trees local and intact, whereas during normal operation subscribers will benefit from the added diversity provided by remote trees.

In the present invention, subscribers detect when the primary tree has not delivered a message to them because of the digest messages they receive on the secondary multicast trees. If retransmission requests up the primary multicast tree repeatedly do not yield a desired message, a secondary tree is henceforth used to deliver messages to the affected subscriber. However, it is inefficient to have a secondary multicast tree deliver full event messages instead of digest messages to all subscribers just so that it can deliver them to a few subscribers who are not able to receive their messages through the primary multicast tree. Accordingly, each node in the secondary multicast tree includes an enable bit 209. Full event messages are only forwarded along a link in the secondary multicast tree when the enable bit 209 of the node is set; otherwise only digest messages are forwarded along the link.

When a subscriber requests that a secondary multicast dissemination tree henceforth deliver full event messages to it, a special request message is forwarded up the tree, which will set the enable bit 209 at each node in the path from the subscriber to the root node. As a consequence, full event messages will only be sent along those tree links that lead to subscribers that have requested them; the rest of the tree and all other subscribers will only be subjected to digest messages.

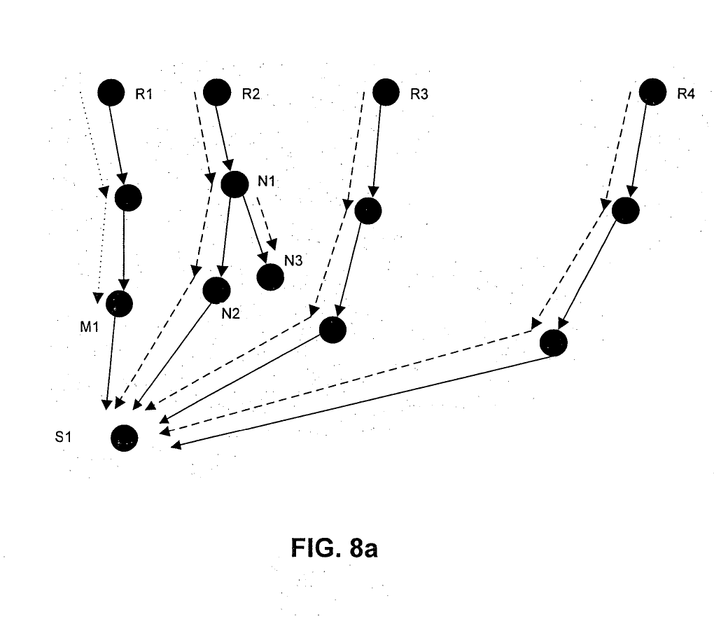

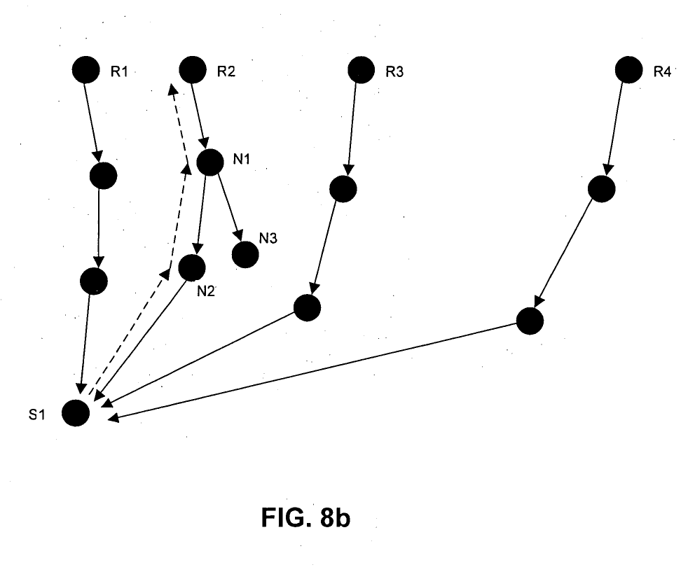

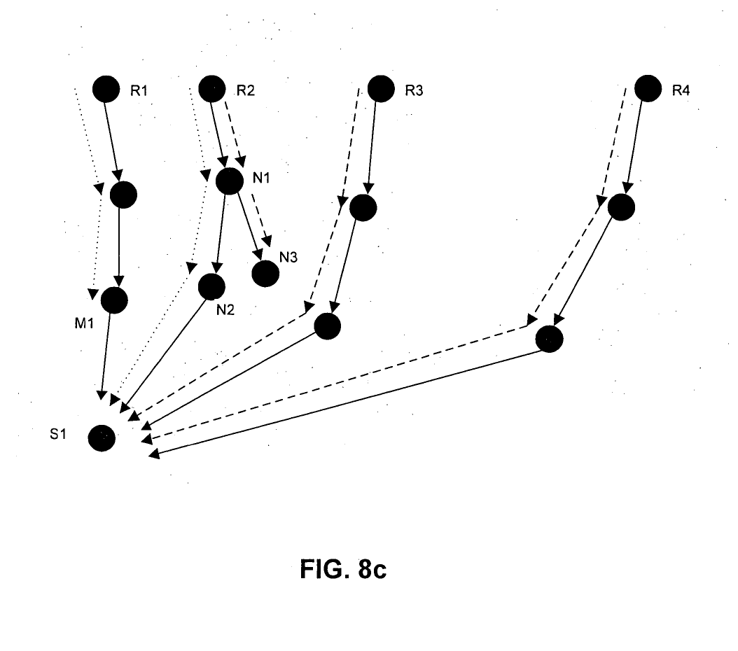

For example, FIG. 8a depicts a plurality of parallel multicast dissemination trees where a full message is transmitted down a path noted by dotted lines, and digest messages are transmitted down paths noted by dashed lines. Note that malicious node M1 fails to forward event messages to subscriber S1. Subscriber S1 is aware that it is not receiving full event messages from its primary tree because it is receiving digest messages from the secondary trees for which a corresponding full message is not received. After retransmission requests fail, subscriber S1 sends a message to root node R2 requesting that full messages be sent to it.

FIG. 8b depicts the path of the request message from subscriber S1 to root node R2 as dashed lines. When intermediate node N2 receives the request message, it understands the message to be a request for full messages, and sets the enable bit 209 associated with the forwarding pointer 210 to subscriber S1. Intermediate node N2 then forwards the request message to intermediate node N1. When intermediate node N1 receives the request message, it understands the message to be a request for full messages, and sets the enable bit 209 associated with the forwarding pointer 210 to intermediate node N2. Intermediate node N1 then forwards the request message to root node R2. When root node R2 receives the request message, it understands the message to be a request for full messages, and sets the enable bit 209 associated with the forwarding pointer 210 to intermediate node N1.

Accordingly, the root node R2 knows to forward a full message to intermediate node N1 because the enable bit 209 is set with respect to the forwarding pointer 210 to intermediate node N1. The intermediate node N1 knows to forward a full message to intermediate node N2 because the enable bit 209 is set with respect to the forwarding pointer 210 to intermediate node N2. The intermediate node N2 knows to forward a full message to subscriber S1 because the enable bit 209 is set with respect to the forwarding pointer 210 to subscriber S1. FIG. 8c shows the result of this process, where a path from R2 to N1 to N2 to S1 is depicted by dotted lines to show that a full message is sent down this path. Note, still only a digest message is sent along the path from R2 to N1 to N3.

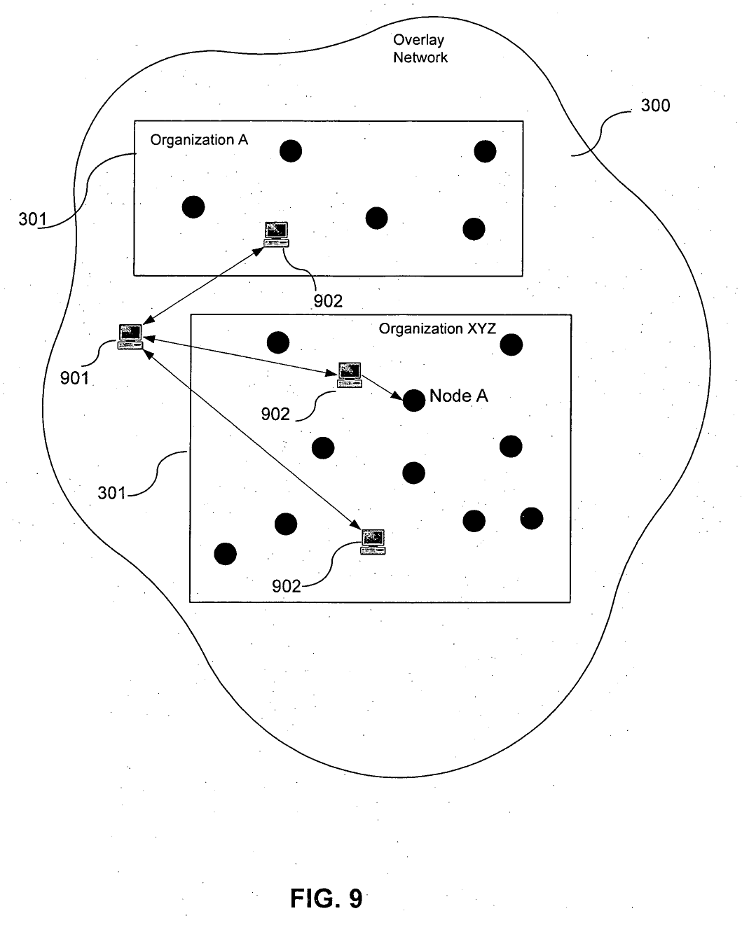

Another embodiment of the invention prevents malicious persons from creating arbitrary numbers of malicious nodes or assigning arbitrary identifiers to any given malicious node within a legitimate organization. To do so, the invention employs a global certificate authority (GCA) 901 and an organizational certificate authority (OCA) 902, as depicted in FIG. 9.

In the present invention, overlay nodes have both a unique string name ID, node name 205, and a random, unique numeric ID, node ID 206. The OCA 902 enforces that a node name 205 consists of a unique organization prefix and an organization-relative suffix. For example, a node might have a node name 205 of xyz.com/building112/machine42 and a node ID of 13729.

When an organization, for example XYZ Inc., first joins the overlay network, it requests a certificate from the GCA 901 that indicates that the organization owns the organizational prefix xyz.com. The organization also requests that the GCA 901 allocate to the organization a batch of unique, randomly distributed numeric IDs for all its machines and a certificate certifying that it owns these numbers. The OCAs 902 of the organization can use the certificates and numeric IDs obtained from the GCA 901, in combination with certified name IDs generated locally, to allocate node names 205 and node IDs 206 to specific machines within the organization. Note that this design allows the GCA 901 to be off-line, since nodes don't actually care which node ID 206 is assigned to them.

Thus, the node owning the name xyz.com/building112/machine42 and the numeric ID 13729 would be issued three certificates by one of the OCAs 902: a certificate from the GCA 901 saying that XYZ's organizational prefix is xyz.com and that numeric ID 13729 belongs to XYZ, a certificate from the GCA 901 saying that the relevant OCA 902 is allowed to allocate node names 205 and node IDs 206 for XYZ, and a certificate from XYZ's OCA 902 saying that building112/machine42 is a legitimate XYZ node name suffix and is bound to 13729.

If malicious nodes can, by means of false routing advertisements, influence honest nodes' routing table entries, then they can subvert event message traffic that does not go directly through them. SkipNet achieves security in this respect because routing tables define a global set of routing rings that are sorted by node name IDs, with each overlay node belonging to at most log N routing rings, where N is the number of nodes in the overlay network. Which routing rings a node belongs to is determined by its numeric ID. The CAs for an organization ensure that malicious nodes cannot obtain arbitrary name IDs and numeric IDs for nodes within the organization. Once a node has been assigned its name ID and numeric ID, the set of routing table pointers it may choose is deterministic.

Nodes within a malicious organization have a degree of freedom that malicious nodes in an “honest” organization do not have: although they can only assume a numeric ID that has been assigned to the organization by the global CA, they can masquerade under any name ID. Fortunately, nodes from a malicious organization can only affect the routing entries of a node in another organization that point in to the malicious organization. In particular, this implies that they cannot subvert pointers internal to a good organization. This is because internal pointers must be to nodes that share the same organizational name prefix.

In view of the many possible embodiments to which the principles of this invention may be applied, it should be recognized that the embodiment described herein with respect to the drawing figures is meant to be illustrative only and should not be taken as limiting the scope of invention. For example, those of skill in the art will recognize that the elements of the illustrated embodiment shown in software may be implemented in hardware and vice versa or that the illustrated embodiment can be modified in arrangement and detail without departing from the spirit of the invention. Therefore, the invention as described herein contemplates all such embodiments as may come within the scope of the following claims and equivalents thereof.

1. A method of providing a scalable multicast infrastructure for multicast messaging on an overlay network including a set of nodes, wherein each node in the set of nodes has a node name indicating a network region of the node, the method comprising:
disseminating messages through a multicast tree formed from a subset of the set of overlay nodes, wherein a root node of the multicast tree belongs to a first network region and a path in the multicast tree is prohibited from re-entering the first network region once the path leaves the first network region.

2. The method of claim 1, wherein the multicast tree is formed by routing a subscription message from a subscriber node in the first network region to the root node, comprising:
receiving the subscription message at a node in the first network region;
recording a forwarding pointer to a previous node from which the message was received; and
forwarding the message to the root node by routing the message to a next node within the first network region, based on a node name of the next node.

3. The method of claim 1, further comprising:
creating a topic for which messages are published;
forming a plurality of multicast trees;
publishing messages about the topic to a root node of each of the plurality of multicast trees; and
forwarding the messages to subscribers through the plurality of multicast trees.

4. The method of claim 3, wherein a subscriber in the first network region finds the topic using a name service comprising a directory of topics published in the first network region.

5. The method of claim 1, wherein a network region is one of a geographic locality and an administrative domain.

6. The method of claim 1, wherein a network region comprises a subset of the set of overlay nodes, and wherein the network region is owned by an organization and each node in the network region also belongs to the organization.

7. The method of claim 6, wherein the node name comprises an organizational indicator indicating ownership by the organization, and an organization-relative indicator that encodes one of a geographic locality and an administrative subdivision within the organization.

8. The method of claim 6, wherein an external node belonging to a second organization sends a subscription message to the root node of the multicast tree, further comprising:
receiving the subscription message at a last node in the second organization,
recording a forwarding pointer to a previous node from which the message was received at the different node, and
determining that a next hop in a routing path to the root node is to a node not in the second organization; and
modifying the subscription message to request than a node in the first organization forward messages directly to the last node.

9. The method of claim 8, further comprising receiving a confirmation message from the node in the first organization.

10. The method of claim 9, wherein, if no confirmation message is received choosing a different node and forwarding the subscription request to the different node.

11. The method of claim 6, wherein an external node belonging to a second organization sends a subscription message to the root node of the multicast tree by determining an internet protocol address of a node in the first organization using a name service and sending the subscription message from the external node to the node belonging to the first organization using a network transport layer underlying the overlay network.

12. The method of claim 3, further comprising maintaining a buffer at each node of each of the plurality of multicast trees to record recent messages.

13. A method of assigning node names to nodes in a scalable multicast infrastructure for multicast messaging on an overlay network, wherein each node has a node name indicating a network region of the node, the node name include an organizational indicator and an organization-relative indicator, the method comprising:
requesting from a global certificate authority a first certificate certifying that an organization owns the organizational indicator;
requesting the global certificate authority to allocate a batch of unique identification numbers to the organization and to issue a second certificate certifying that the organization owns the batch of unique identification numbers;
receiving the first and second certificates;
issuing to a node owned by the organization the first and second certificates;
allocating one of the batch of unique identification numbers to the node;
allocating to the node a node name including the organization indicator and the organization-relative indicator; and
issuing to the node a third certificate, from the organizational certificate authority, certifying that the organization-relative indicator of the node is validly associated with the organization and is bound to the one of the batch of unique identification numbers.

14. The method of claim 13, wherein a network region is one of a geographic locality and an administrative domain.

15. The method of claim 13, wherein a network region comprises a subset of nodes in the overlay network, and wherein the network region is owned by an organization and each node in the network region also belongs to the organization.

16. The method of claim 13, wherein the organization-relative indicator encodes one of a geographic locality and an administrative subdivision within the organization.

17. The method of claim 13, further comprising:
requesting a fourth certificate from the global certificate authority certifying that the organizational certificate authority is authorized to allocate the unique identification number and the node name to the node;
receiving the fourth certificate; and
issuing the fourth certificate to the node.

18. A method of providing a scalable multicast infrastructure for multicast messaging on an overlay network including a set of nodes, the method comprising:
forming a primary multicast tree from a subset of the set of overlay nodes, the multicast tree including a root node and one or more subscriber nodes;
passing an event message from the root node to the one or more subscriber nodes through the primary multicast dissemination tree; and
ensuring delivery of the event message by a first method when message traffic occurs above a predetermined level, and ensuring delivery of the event message by a second method when message traffic is not above the predetermined level.

19. The method of claim 18, wherein the first method includes periodically sending one of an event message and a heartbeat message at a predetermined interval, wherein the one or more subscriber nodes determines a tree disconnect when the one of an event message and a heartbeat message is not received at the predetermined interval.

20. The method of claim 18, wherein the second method includes:
forming a plurality of secondary multicast trees, each secondary multicast tree including a subset of the set of overlay nodes, wherein each secondary multicast tree includes a different root node and shares a common subscriber node that is one of the one or more subscriber nodes of the primary multicast tree;
passing the event message from the root node of the primary multicast dissemination tree and the root node of each secondary multicast dissemination tree to the common subscriber node; and
determining a primary multicast tree disconnect when the event message is received from a root node of one of the plurality of secondary multicast trees and the event message is not received from the root node of the primary multicast tree.

21. The method of claim 20, wherein a full event message is passed from the root node of the primary multicast tree, and a digest of the full event message is passed from the root node of each secondary multicast tree.

22. The method of claim 21, wherein the second method further includes:
sending a request message from the common subscriber node to a root node of one of the plurality of secondary multicast trees when the full event message is not received, the request message indicating that full event messages should be passed to the common subscriber node; and
setting an enable bit at each of a plurality of nodes in a path between the root node of one of the plurality of secondary multicast trees and the common subscriber node, the enable bit indicating that a full event message should be forwarded down the path.

23. The method of claim 20, wherein the root node of the primary multicast tree is located in a same network region as the common subscriber node and the root nodes of the plurality of secondary multicast trees are located at increasing distances from the common subscriber node.

24. The method of claim 23, wherein a network region is one of a geographic locality and an administrative domain.

25. A method of participating in a scalable multicast infrastructure for multicast messaging on an overlay network including a set of nodes, the method comprising:
joining a first multicast tree including overlay nodes in an overlay routing path between a subscriber node and a root node of the first multicast tree; and
joining a second multicast tree formed from the first multicast tree, wherein the second multicast tree includes a subset of the overlay nodes in the first multicast tree, the subset consisting of only nodes that voluntarily participate in message dissemination.

26. The method of claim 25, wherein the first multicast tree includes a plurality of subscribers.

27. The method of claim 25, wherein joining the first multicast tree includes sending a subscription message from a first node addressed to a root node through the overlay network, each node in the overlay routing path:
receiving the subscription message at an intermediate node from a preceding node;
recording a tree forwarding pointer that points to the preceding node at the intermediate node; and
forwarding the subscription message to a next node, wherein the subscription message stops when it reaches one of the root node and another node in the first multicast tree.

28. The method of claim 27, wherein forming the second multicast tree includes assuming forwarding duties of a non-participating node that does not wish to participate in message dissemination, wherein forwarding duties includes forwarding event messages received from a parent node of the non-participating node to a child node of the non-participating node.

29. The method of claim 28, wherein delegating forwarding duties includes:
generating at a participating node a unique delegation ticket that includes a pointer to the participating node; and
passing a unique delegation ticket to an ancestor node of the participating node that is the non-participating node, wherein an ancestor node of the non-participating node is directed to forward messages directly to the participating node.

30. The method of claim 29, further comprising generating only one delegation ticket.

31. The method of claim 29, wherein the non-participating node must pass the delegation ticket to an ancestor node if the ancestor node is also a non-participating node.

32. The method of claim 25, wherein joining the second multicast tree includes:
receiving at the subscriber node a probe message from a node in the second tree, wherein each node in the first tree receiving the subscription message forwards the subscription message through the first tree until the subscription message is received by the node in the second tree; and
sending a message to the node in the second tree instructing the node in the second tree to forward messages directly to the subscriber node.

33. The method of claim 25, wherein, when the subscription message is received at a first node in the first tree, the first node forwards the subscription message to a parent node of the first node if the first node is not a node in the second tree and has not previously forwarded a subscription message to the parent node.

34. The method of claim 25, wherein, when the subscription message is received at a first node in the first tree, the first node forwards the subscription message to a child node of the first node if the first node not a node in the second tree and has previously forwarded a subscription message to the parent node.

35. The method of claim 32, further comprising creating a failure notification group including every node receiving the subscription message, wherein the failure notification group is created using a failure notification service, and wherein the failure notification service removes a relevant state if a failure is ascertained.

36. A computer readable medium having computer-executable instructions for performing the steps of claim 1.

37. A computer readable medium having computer-executable instructions for performing the steps of claim 18.

38. A computer readable medium having computer-executable instructions for performing the steps of claim 25.
